(19) United States
(12) Patent Application Publication
(10) Pub. No.: US 2015/0277647 A1
(43) Pub. Date: Oct. 1, 2015

(54) PRESSURE-SENSITIVE ELEMENT, METHOD OF PRODUCING THE PRESSURE-SENSITIVE ELEMENT, TOUCH PANEL EQUIPPED WITH THE PRESSURE-SENSITIVE ELEMENT, AND METHOD OF PRODUCING THE PRESSURE-SENSITIVE ELEMENT

(71) Applicant: Panasonic Intellectual Property Management Co., Ltd., Osaka (JP)

(72) Inventors: TETSUYOSHI OGURA, Osaka (JP); AKI YAZAWA, Hyogo (JP)

(21) Appl. No.: 14/551,004

(22) Filed: Nov. 22, 2014

(30) Foreign Application Priority Data
Mar. 31, 2014 (JP) 2014-073527

(51) Int. Cl. G06F 3/041; G06F 1/16

(52) U.S. Cl. CPC G06F 3/0414; G06F 1/16; G06F 2203/04103; G06F 2203/04102

(57) ABSTRACT

A pressure-sensitive element of the present disclosure includes a substrate, a conductive structure, an elastic electrode portion, and an electrode supporting component. The conductive structure extends from the substrate. The elastic electrode portion opposes a tip of the conductive structure. The electrode supporting component opposes the substrate with the conductive structure and the elastic electrode portion interposed therebetween, supports the elastic electrode portion, and has flexibility. In the pressure-sensitive element, the conductive structure includes a structural component which extends from the substrate and which has a higher elastic modulus than that of the elastic electrode portion, and a conductive layer which is coated on a surface of the structural component. In the pressure-sensitive element, the elastic electrode portion has a flat surface which opposes the conductive structure and which is capable of being brought into contact with the conductive structure.

This Application claims priority to Japanese Patent Application No. 2014-073527, filed on Mar. 31, 2014, the contents of which are hereby incorporated by reference.

### BACKGROUND

1. Technical Field

The technical field relates to a pressure-sensitive element and a method of producing the pressure-sensitive element. The technical field also relates to a touch panel equipped with the pressure-sensitive element and a method of producing the touch panel.

2. Description of the Related Art

Nowadays, various electronic devices equipped with touch panels such as smartphones and car navigation systems are increasingly sophisticated and diversified. Along with this trend, as a structural element of these electronic devices, a pressure-sensitive element, which can accurately and reliably detects a change in the pressing force, is demanded.

For example, a pressure-sensitive element described in Japanese Unexamined Patent Application Publication No. 2008-311208 includes a substrate, a pressure-sensitive conductive sheet, and a plurality of electrodes. The pressure-sensitive conductive sheet opposes and is spaced apart from the substrate. The plurality of electrodes, which are formed of silver, carbon, copper, or the like, are provided on the substrate so as to be interposed between the substrate and the pressure-sensitive conductive sheet. The electrodes are connected to circuitry of an electronic device through leads or the like. The pressure-sensitive conductive sheet includes a conductive layer and particles of, for example, urethane or glass. The elastic conductive layer is brought into contact with the electrodes. The particles, the particle size of which is several ten to hundred μm, are dispersed in the conductive layer. The surface of the conductive layer opposite the electrodes has irregular protrusions and recesses formed by the plurality of particles dispersed in the conductive layer.

In the pressure-sensitive element described in Japanese Unexamined Patent Application Publication No. 2008-311208, when the pressure-sensitive conductive sheet is pressed, the surface, which has the protrusions and recesses, of the conductive layer of the pressure-sensitive conductive sheet is brought into contact with the plurality of electrodes disposed at the substrate. This causes the plurality of electrodes to be electrically connected to one another through the conductive layer. When the pressure-sensitive conductive sheet is further pressed, the conductive layer is deformed. This causes a contact area between the conductive layer and the electrodes to be increased, and accordingly, the resistance between the electrodes is reduced. In accordance with a change in this resistance, the pressure-sensitive element according to the Japanese Unexamined Patent Application Publication No. 2008-311208 detects the pressing force acting on the pressure-sensitive conductive sheet.

As another example, a pressure-sensitive element described in Japanese Unexamined Patent Application Publication No. 2012-208038 includes a first insulating film, a first electrode, a conductive elastic body, a second electrode, and a second insulating film. The first electrode is provided on the first insulating film. The conductive elastic body is provided on the first electrode and has a plurality of protrusions having a truncated polygonal pyramid shape (for example, truncated quadrangular pyramid shape). The second electrode opposes the tips of the protrusions of the conductive elastic body. The second insulating film supports the second electrode. The first and second electrodes are formed of copper, silver, gold, stainless steel, or the like. When the second insulating film is pressed, the first electrode and the second electrode are electrically connected to each other through the conductive elastic body.

### SUMMARY

The present disclosure reduces variation of change in the resistances between a plurality of pressure-sensitive elements corresponding to a change in a pressing force and improves the durability of the pressure-sensitive element.

According to an aspect of the present disclosure, a pressure-sensitive element includes a substrate, a conductive structure, an elastic electrode portion, and an electrode supporting component. The conductive structure extends from the substrate. The elastic electrode portion opposes a tip of the conductive structure. The electrode supporting component opposes the substrate with the conductive structure and the elastic electrode portion interposed therebetween, supports the elastic electrode portion, and has flexibility. In the pressure-sensitive element, the conductive structure includes a structural component which extends from the substrate and which has a higher elastic modulus than that of the elastic electrode portion, and a conductive layer which is coated on a surface of the structural component. In the pressure-sensitive element, the elastic electrode portion has a flat surface which opposes the conductive structure and which is capable of being brought into contact with the conductive structure.

According to the aspect of the present disclosure, variation of change in the resistance corresponding to a change in the pressing force can be reduced, and the durability of the pressure-sensitive element can be improved.

### BRIEF DESCRIPTION OF THE DRAWINGS

FIG. 1 is an exploded perspective view of part of a pressure-sensitive element according to a first embodiment of the present disclosure.

FIG. 2 is a schematic sectional view of the pressure-sensitive element according to the first embodiment of the present disclosure.

FIG. 3 illustrates an example of an elastic electrode portion according to the first embodiment.

FIG. 4 illustrates another example of the elastic electrode portion according to the first embodiment.

FIG. 5 illustrates yet another example of the elastic electrode portion according to the first embodiment.

FIG. 6 illustrates yet another example of the elastic electrode portion according to the first embodiment.

FIG. 7 is a schematic sectional view of the pressure-sensitive element according to the first embodiment to which a pressing force is applied.

FIG. 8 is a sectional view of as example of the structure of as elastic electrode portion according to the first embodiment.

FIG. 9 is a sectional view of another example of the structure of the elastic electrode portion according to the first embodiment.

FIG. 10 illustrates changes in the electrical resistance in a plurality of the pressure-sensitive elements, which include the elastic electrode portions having different elastic moduli, corresponding to a change in the pressing force.

FIG. 11 illustrates a change in the electrical resistance corresponding to a change in the pressing force acting on the pressure-sensitive element.

FIG. 12 illustrates an example of the shape of a conductive structure according to the first embodiment.

FIG. 13A is a schematic sectional view of a pressure-sensitive element according to a second embodiment of the present disclosure.

FIG. 13B is a schematic sectional view of the pressure-sensitive element, according to the second embodiment to which a relatively small pressing force is applied.

FIG. 13C is a schematic sectional view of the pressure-sensitive element according to the second embodiment to which a relatively large pressing force is applied.

FIG. 14A is a schematic sectional view of a pressure-sensitive element according to a third embodiment of the present disclosure.

FIG. 14B is a schematic sectional view of the pressure-sensitive element according to the third embodiment to which a relatively small pressing force is applied.

FIG. 14C is a schematic sectional view of the pressure-sensitive element according to the third embodiment to which a relatively large pressing force is applied.

FIG. 15 is a perspective view of part of a pressure-sensitive element according to a fourth embodiment of the present disclosure.

FIG. 16 is a perspective view of another example of a conductive structure according to the fourth embodiment.

FIG. 17 is a schematic sectional view of a touch panel according to an embodiment of the present disclosure.

FIG. 18A is a sectional view illustrating a step of a method of producing the pressure-sensitive element according to the embodiments of the present disclosure.

FIG. 18B is a sectional view illustrating a step that follows the step illustrated in FIG. 18A.

FIG. 18C is a sectional view illustrating a step that follows the step illustrated in FIG. 18B.

FIG. 18D is a sectional view illustrating a step that follows the step illustrated in FIG. 18C.

FIG. 19 is a perspective view of part of the pressure-sensitive element according to the first embodiment of the present disclosure.

FIG. 20 is a perspective view of part of the pressure-sensitive element according to the first embodiment of the present disclosure.

FIG. 21 illustrates yet another example of the elastic electrode portion according to the first embodiment.

### DETAILED DESCRIPTION

### Findings Underlying Present Disclosure

Before describing forms of implementation according to the present disclosure, what the disclosers have discussed is initially described.

For example, in the case of a pressure-sensitive element described in Japanese Unexamined Patent Application Publication No. 2008-311208, particles of urethane, glass, or the like having different particle sizes are irregularly contained in a conductive layer. Thus, the surface of the conductive layer opposing electrodes has irregular protrusions and recesses. Accordingly, among a plurality of pressure-sensitive elements, the conductive layers are in contact with the plurality of electrodes in a non-uniform state. As a result, it has been found that, even when the pressing forces acting on the plurality of pressure-sensitive elements are uniformly changed, change in the resistances between the plurality of electrodes varies from pressure-sensitive element to pressure-sensitive element.

In a pressure-sensitive element described in Japanese Unexamined Patent Application Publication No. 2012-208038, a plurality of protrusions, which have the same shape, of an conductive elastic body are brought into contact with a planar portion of a second electrode, thereby reducing variation of change in the resistance between the electrodes. However, when the protrusions of the conductive elastic body are repeatedly deformed by repeatedly pressing the pressure-sensitive element, repeated stress is concentrated in the bottoms of the protrusions. This may cause cracks in the bottom portions, and the conductive elastic body may partially break clue to growth of the cracks. Thus, the disclosers have found that the pressure-sensitive element described in Japanese Unexamined Patent Application Publication No. 2012-208038 may have a low durability.

The disclosers thought of disclosure of forms of implementation according to the present disclosure on the basis of the above-described findings.

Hereafter, a pressure-sensitive element according to embodiments of the present disclosure will be described with reference to the drawings.

### Description of Present Disclosure

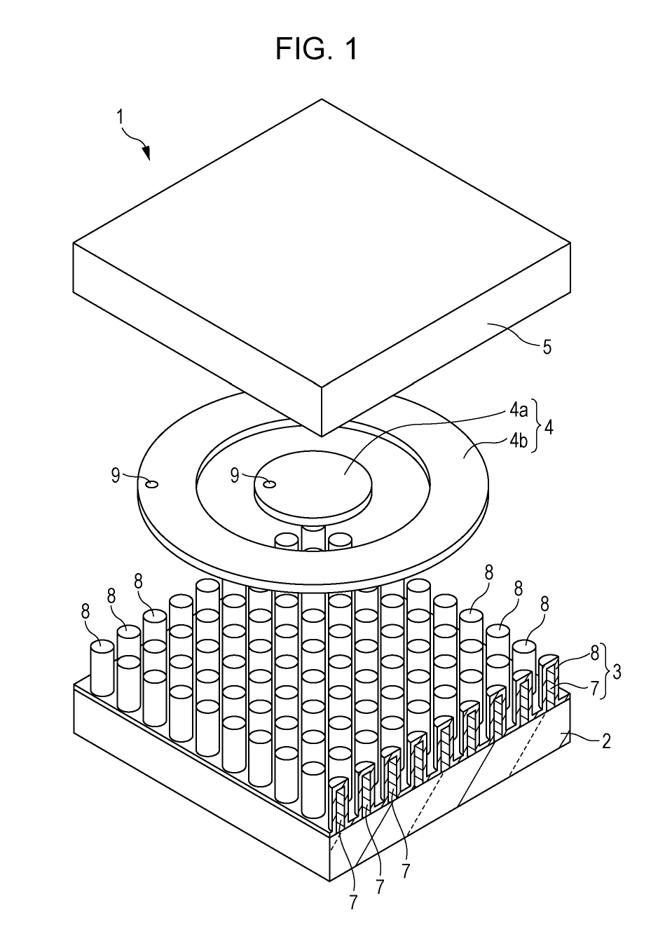

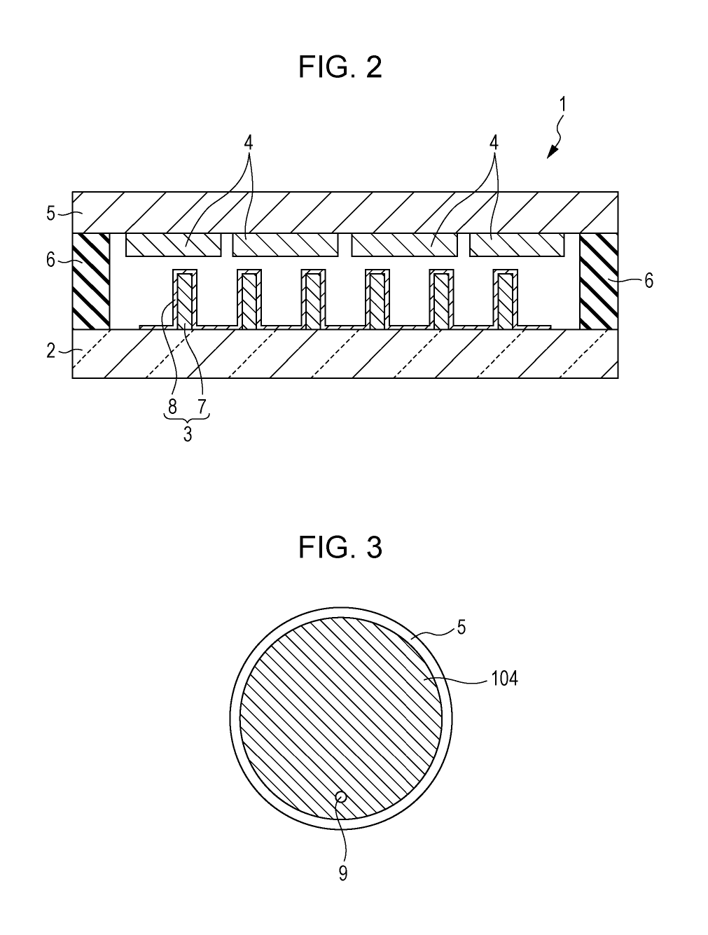

FIG. 1 is an exploded, perspective view of part of a pressure-sensitive element according to a first embodiment of the present disclosure. FIG. 2 is a sectional view of the pressure-sensitive element according to the first embodiment of the present disclosure.

As illustrated in FIGS. 1 and 2, a pressure-sensitive element 1 includes a substrate 2, conductive structures 3, and an electrode supporting component 5. The conductive structures 3 are provided on the substrate 2. The electrode supporting component 5 opposes the substrate 2 with the conductive structures 3 interposed therebetween.

The electrode supporting component 5 is a flexible plate-shaped elastic member. An elastic electrode portion 4 is provided at the electrode supporting component 5. The elastic electrode portion 4 is supported by the electrode supporting component 5 such that the elastic electrode portion 4 opposes the tips of the conductive structures 3. The elastic electrode portion 4 has a flat surface that opposes and is to be brought into contact with the conductive structures 3, which will be described later. The reason for this will be described later.

The electrode supporting component 5 opposes the substrate 2 so as to be parallel to and spaced apart from the substrate 2 with spacers 6 disposed therebetween. That is, the conductive structures 3, the elastic electrode portion 4, and the spacers 6 are disposed between the substrate 2 and the electrode supporting component 5. The spacers 6 are formed of an insulating resin such as a polyester resin or an epoxy resin.

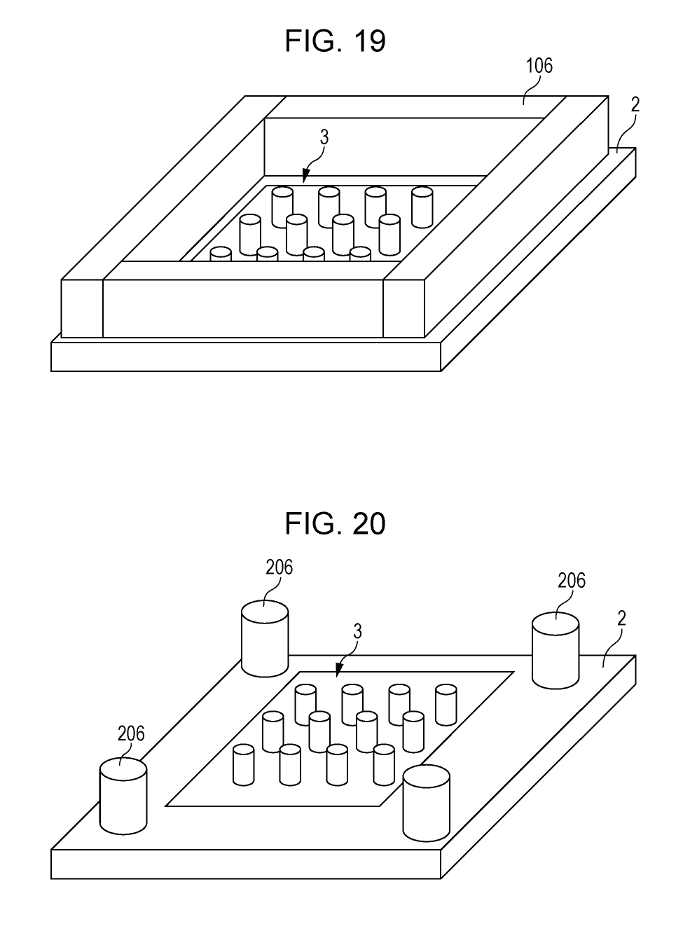

The spacer may be a frame-shaped spacer 106 that surrounds a plurality of the conductive structures 3 as illustrated in FIG. 19. Alternatively, the spacer may be the columnar spacer 206. In this case, as illustrated in FIG. 20, a plurality of the columnar spacers 206 are disposed on the substrate 2 such that the substrate 2 s dotted with the spacers 206. When the substrate 2 is dotted with the plurality of spacers 206, the spacers 206 may have any of a columnar shape, a spherical shape, a semi-spherical shape, and a frusto-conical shape.

The substrate 2 has, for example, flexibility. The “flexibility” of the substrate 2 here refers to properties, with which the substrate 2 is pliable and deformed without causing cracks when the substrate 2 is bent. When the substrate 2 has flexibility, the pressure-sensitive element 1 can be bonded to a curved surface through the substrate 2. That is, the pressure-sensitive element 1 can be disposed on devices (for example, a display and so forth) of various shapes. Although the material of the substrate 2 is not particularly limited, the substrate 2 is formed of, for example, a plastic such as polyethylene terephthalate, polycarbonate, or polyimide. The thickness of the substrate 2 is, for example, 25 to 500 μm when considering the durability and reduction of the thickness of the pressure-sensitive element 1.

As illustrated in FIGS. 1 and 2, the conductive structures 3 include structural components 7 and a conductive layer 8. The structural components 7 extend from the substrate 2 in a direction in which the substrate 2 and the electrode supporting component 5 oppose each other. The conductive layer 8 is coated on the structural components 7. It is sufficient that the structural components 7 extend from the substrate 2 such that the structural components 7 are substantially perpendicular to the substrate 2 and such that the tips of the structural components 7 oppose the elastic electrode portion 4. The structural components 7 extend from the substrate 2, for example, at an angle in a range from 60 to 90 degrees, that is, in a range, for example, from 70 to 90 degrees relative to the substrate 2.

Also, as illustrated in FIGS. 1 and 2, in the first embodiment, the conductive structures 3 (structural components 7) are a plurality of columnar structures (structural components) that are spaced apart from one another on the substrate 2. In the first embodiment, the plurality of conductive structures 3 (structural components 7) have a uniform length from the substrate 2 to the tips thereof and are arranged on the substrate 2 in a regular manner. For example, the plurality of conductive structures 3 are arranged in a matrix. Thus, the conductive structures 3 have a regular structure.

Although the dimensions of the columns of the conductive structures 3 are not particularly limited, the diameter and the height of the columns are, for example, respectively 10 to 500 μm and 10 to 500 μm. When the diameter is less than 10 μm, stress exerted on the elastic electrode portion 4 increases and resistance to degradation is reduced. When the diameter is more than 500 μm, pressure-sensitive characteristics may vary due to defects in the surface of the column or variation of the surface roughness of the surface of the column. When the height of the columns is less than 10 μm, the elastic electrode portion 4 may be brought into contact with the conductive layer 8 of the substrate 2 in the middle of pressing, and accordingly, the pressure-sensitive characteristics cannot be obtained. When the height of the columns is more than 500 μm, the conductive structures 3 may by when the conductive structures 3 are repeatedly pressed.

When the columns of the conductive structures 3 have the dimensions as described above, the columns of the conductive structures 3 are spaced apart from one another by, for example, 10 to 200 μm, and about, for example, 1000 to 15000 columns per cm⁻² are formed. When the number of columns of the conductive structures 3 is less than 1000/cm², the contact area between the conductive layer 8 and the elastic electrode portion 4 is insufficient, and accordingly, the resistance between the elastic electrode portion 4 and the conductive layer 8 is not sufficiently reduced even when the pressing force is increased. When the number of columns of the conductive structures 3 is more than 15000, the contact area between the conductive structures 3 and the elastic electrode portion 4 is large even when the pressing force is small. This causes steep reduction in the resistance between the elastic electrode portion 4 and the conductive layer 8. However, the above description does not limit the number of the conductive structures 3. An optimum number of the conductive structures 3 is determined in accordance with the contact resistance of the conductive structures 3 with the elastic electrode portion 4 in addition to the dimensions of the conductive structures 3.

Although the material of the structural components 7 of the conductive structures 3 is not particularly limited in the first embodiment, the structural components 7 are formed of a material such as, for example, a silicone based resin such as polydimethyl polysiloxane (PDMS), a styrene based resin, an acrylic resin, or a rotaxane based resin.

Although the details will be described later, the structural components 7 of the conductive structures 3 have a higher elastic modulus than that of the elastic electrode portion 4. The elastic modulus of the structural components 7 is higher than, for example, 108 Pa. The elastic modulus or the structural components 7 can be adjusted by changing the elastic modulus of the material (resin material) of the structural components 7.

The conductive layer 8 of the conductive structures 3 having a uniform thickness is coated on the surface of the substrate 2 and the surfaces of the plurality of structural components 7 provided on the substrate 2. Thus, the conductive structures 3, in which the plurality of structural components 7 and the conductive layer 8 are integrated with one another, are formed on the substrate 2.

As illustrated in FIG. 1, in the first embodiment, a contact portion of the elastic electrode portion 4 is divided into a plurality of contact pieces, which oppose and are brought into contact with the tips of the conductive structures 3. That is, a circular contact piece 4a is surrounded by an annular contact piece 4b. The contact pieces 4a and 4b have respective flat surfaces to be brought into contact with the conductive structures 3 and respective electrical outlets 9.

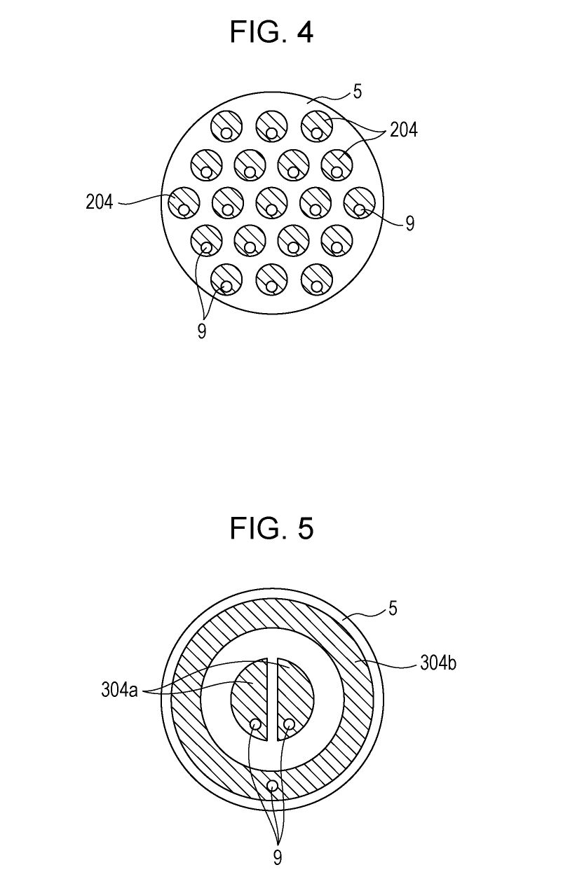

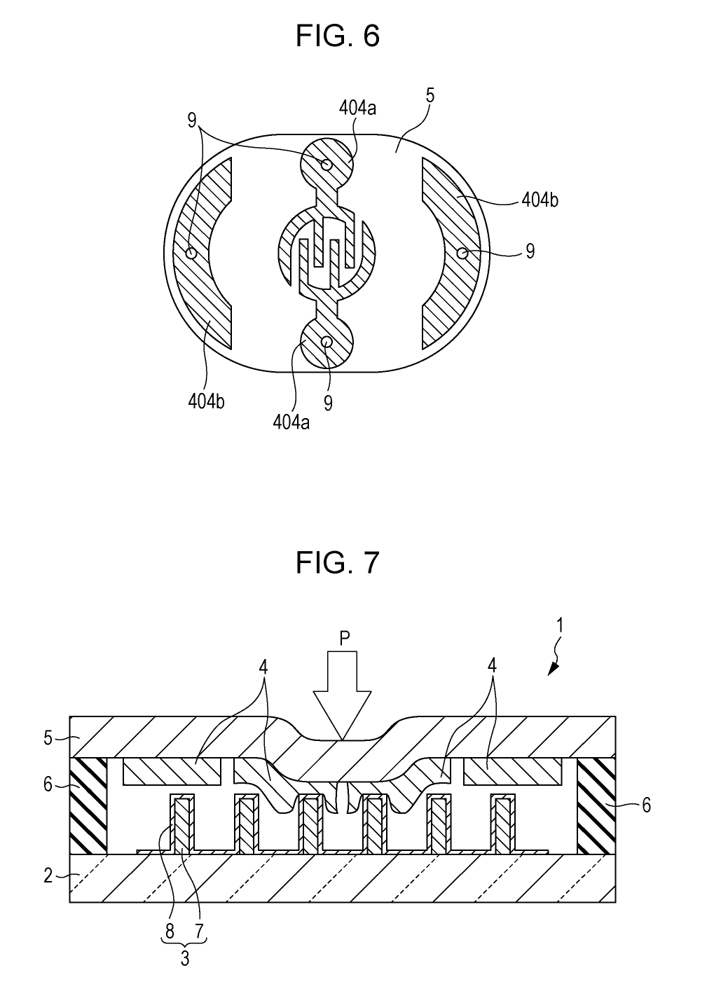

The elastic electrode portion 4 is not necessarily has the contact pieces that are patterned as illustrated in FIG. 1. The elastic electrode portion 4 may have a single circular contact piece 104 formed in the entirety of the electrode supporting component 5 as illustrated in FIG. 3. Alternatively, as illustrated in FIG. 4, the contact pieces of the elastic electrode portion 4 may be circular contact pieces 204 arranged in the electrode supporting component 5 in a regular manner. Alternatively, as illustrated in FIG. 5, the contact pieces of the elastic electrode portion 4 may be a pair of semi-circular central contact pieces 304a, which oppose each other, and an annular circumferential contact piece 304b, which surrounds the pair of circular contact pieces 304a. Alternatively, as illustrated in FIG. 6, the contact pieces of the elastic electrode portion 4 may be a pair of central contact pieces 404a having respective comb-like parts, the teeth of which are alternately arranged along the adjacent ends of the contact pieces 404a, and arc-shaped circumferential contact pieces 404b that oppose each other with the pair of comb-shaped contact pieces 404a interposed therebetween.

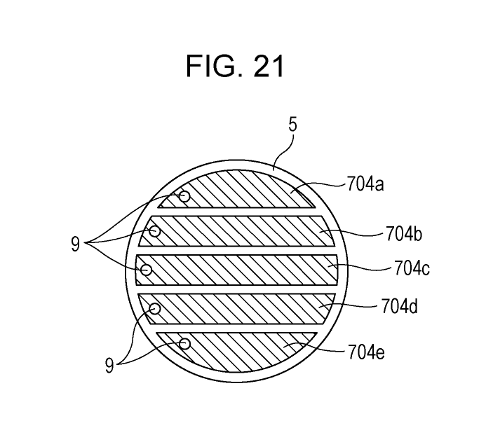

Alternatively, as illustrated in FIG. 21, the contact portion of the elastic electrode portion 4 may be divided into a plurality of contact pieces 704a to 704e, which are parallel to one another and spaced apart from one another. The gap between the adjacent contact pieces is about, for example, 1 to 10 mm although it varies depending on application.

As illustrated in FIG. 2, in a broad sense, the elastic electrode portion 4 does not have a protruding part or protruding parts that protrude toward the substrate 2 and are brought into contact with the conductive structures 3, but has a flat surface or flat surfaces that oppose and are to be brought into contact with the conductive structures 3.

With the pressure-sensitive element 1 that includes the elastic electrode portion 4 having the contact pieces or the contact piece as illustrated in FIGS. 1 and 3 to 6, a change in the pressing force acting on the pressure-sensitive element 1 can be detected in accordance with a change in the resistance between the elastic electrode portion 4 and the conductive layer 8 of the conductive structures 3. That is, as illustrated in FIG. 7, as a pressing force P that presses the electrode supporting component 5 toward the substrate 2 is increased, the contact area between the conductive structures 3 and the elastic electrode portion 4 is increased. Thus, the resistance between the elastic electrode portion 4 and the conductive layer 8 of the conductive structures 3 is increased.

With the pressure-sensitive element 1 that includes the elastic electrode portion 4, the contact portion of which have a plurality of contact patterns as illustrated in FIGS. 1 and 4 to 6, a change in the pressing force acting on the pressure-sensitive element 1 can be detected in accordance with changes in the resistances between the plurality of contact pieces of the elastic electrode portion 4.

That is, as illustrated in FIG. 7, as the pressing force P that presses the electrode supporting component 5 toward the substrate 2 is increased, the contact area between the conductive structures 3 and the elastic electrode portion 4 is increased. Thus, the resistances between the plurality of contact pieces of the elastic electrode portion 4, which are electrically connected to one another by the conductive structures 3, are reduced.

Furthermore, when the elastic electrode portion 4 has three or more contact pieces as illustrated in FIGS. 4 to 6, a position in the electrode supporting component 5, on which the pressing force acts, can be detected in accordance with changes in the resistances between various combinations of the contact pieces.

Furthermore, when the elastic electrode portion 4 includes a central and circumferential contact pieces as illustrated in FIGS. 1, 5, and 6, poor contact that locally occurs between the elastic electrode portion 4 and the conductive structures 3 can be canceled off. As a result, a change in the resistance can be stably detected.

With the pair of central contact pieces 404a having respective comb-like parts, the teeth of which are alternately arranged along the adjacent ends of the contact pieces 404a, and the arc-shaped circumferential contact pieces 404b, which oppose each other with the pair of comb-shaped contact pieces 404a interposed therebetween as illustrated in FIG. 6, even when the position of the electrode supporting component 5 relative to the substrate 2 varies due to variation in the manufacture of the pressure-sensitive element 1, the pressure-sensitive element 1 can stably detect a change in the resistance.

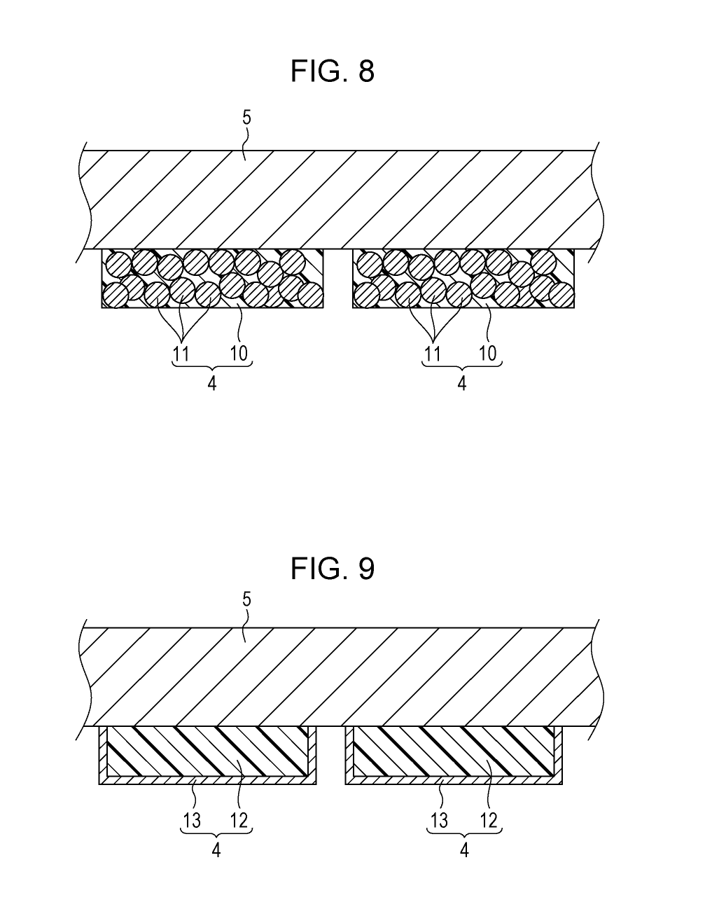

As illustrated in FIG. 8, the elastic electrode portion 4 includes a resin layer 10 provided at the electrode supporting component 5 and a plurality of conductive filler elements 11 uniformly contained in the resin layer 10.

The particle size of the conductive filler elements 11 is sufficiently smaller than the patterned shape of the elastic electrode portion 4, and is about, for example, several hundred nm or smaller. The conductive filler elements 11 may have a shape such as a spherical shape, a plate shape or a needle shape.

The resin layer 10 is formed of, for example, a urethane resin, a styrene based resin, a silicone based resin such as polydimethyl polysiloxane (PDMS), an acrylic resin, or an elastic resin such as a rotaxane based resin. The conductive filler elements 11 are formed of a material selected from the group consisting of, for example, Au, Ag, Cu, C, ZnO, In₂O₃, SnO₂, and so forth.

When the electrode supporting component 5 is pressed, part of the elastic electrode portion 4, which corresponds to the pressed part of the electrode supporting component 5, is uniformly deformed in accordance with the elastic property of the elastic electrode portion 4. At this time, a total contact area between the conductive filler elements 11 contained in the deformed elastic electrode portion 4 also changes. Accordingly, the conductivity of the elastic electrode portion 4 changes. As a result, although the details will be described later, the resistance between the elastic electrode portion 4 and the conductive layer 8 of the conductive structures 3 (or resistances between the plurality of the contact pieces of the elastic electrode portion 4) is significantly changed corresponding to a change in the pressing force acting on the electrode supporting component 5.

Alternatively, as illustrated in FIG. 9, the elastic electrode portion 4 may include a resin layer 12 provided at the electrode supporting component 5 and a conductive layer 13 coated on the resin layer 12. The conductive layer 13 is formed so that the resin layer 12 is coated with the conductive layer 13 of a uniform thickness.

When the elastic electrode portion 4 is brought into contact with the conductive structures 3 by pressing the electrode supporting component 5, the resin layer 12 and the conductive layer 13 are compressed, and the thickness of the conductive layer 13 is reduced. Accordingly, the resistance of the elastic electrode portion 4 is increased. This increases the smoothness, with which the resistance among the elastic electrode portion 4 and the conductive structures 3 (or the resistances between the plurality of the contact pieces of the elastic electrode portion 4) is changed corresponding to a change in the pressing force acting on the electrode supporting component 5.

The elastic modulus of the elastic electrode portion 4 is, as described above, lower than that of the structural components 7 of the conductive structures 3. For example, the elastic modulus of the elastic electrode portion 4 is about 104 to 108 Pa so that the elastic electrode portion 4 is gradually deformed at about 1 to 10 N, which is the pressing force when the pressure-sensitive element 1 is used as a pressure-sensitive switch.

As described above, the elastic modulus of the structural components 7 of the conductive structures 3 is higher than that of the elastic electrode portion 4. That is, as illustrated in FIG. 7, the conductive structures 3 and the elastic electrode portion 4 are formed so that, when the elastic electrode portion 4 and the conductive structures 3 are brought into contact with one another by the pressing force P acting on the electrode supporting component 5, the elastic electrode portion 4 is deformed while the conductive structures 3 are not deformed.

When the elastic electrode portion 4 has the resin and the plurality of conductive filler elements contained in the resin as illustrated in FIG. 8, the elastic modulus of the elastic electrode portion 4 is adjusted by changing, for example, mechanical characteristics of the resin layer 10, mechanical characteristics and the shape of the conductive filler elements 11, and the ratio of the resin layer 10 to the conductive filler elements 11.

When the elastic electrode portion 4 has the resin and the conductive layer coated on the resin as illustrated in FIG. 9, the elastic modulus of the elastic electrode portion 4 is adjusted by changing mechanical characteristics of the resin layer 12.

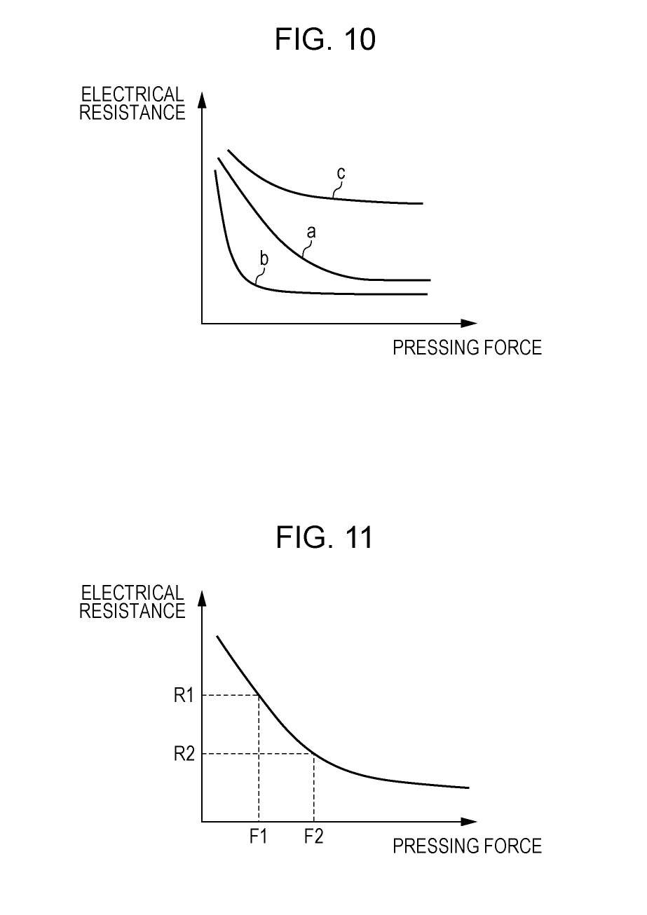

FIG. 10 illustrates electrical resistance characteristics of pressure-sensitive elements a to c, which include the respective elastic electrode portions 4 having different elastic characteristics.

Specifically, FIG. 10 illustrates changes in the electrical resistance between the elastic electrode portion 4 and the conductive layer 8 of the conductive structures 3 corresponding to a change in the pressing force acting on the electrode supporting component 5 of the pressure-sensitive elements a to c. The pressure-sensitive element a has the elastic electrode portion 4 having an elastic modulus of 104 to 108 Pa. The pressure-sensitive element b has the elastic electrode portion 4 having a lower elastic modulus than 104 Pa. The pressure-sensitive element c has the elastic electrode portion 4 having a higher elastic modulus than 108 Pa.

Referring to FIG. 10, with the pressure-sensitive element b, even when the pressing force acting on the electrode supporting component 5 is relatively small, the elastic electrode portion 4 easily changes and the contact area between the conductive structures 3 and the elastic electrode portion 4 is steeply increased. That is, the resistance is significantly reduced by a small pressing force. Thus, with the pressure-sensitive element b, it is unlikely that a change in the pressing force is highly accurately detected in accordance with a change in the resistance.

Referring to FIG. 10, with the pressure-sensitive element c, even when the pressing force acting on the electrode supporting component 5 is relatively increased, the elastic electrode portion 4 is not easily deformed. Accordingly, the contact area between the conductive structures 3 and the elastic electrode portion 4 is changed little. Thus, even when the pressing force is changed, the resistance between the elastic electrode portion 4 and the conductive layer 8 of the conductive structures 3 is changed little. Thus, with the pressure-sensitive element c, it is unlikely that a change in the pressing force is accurately detected in accordance with a change in the resistance.

In comparison with the pressure-sensitive elements b and c, with the pressure-sensitive element a, the contact area between the conductive structures 3 and the elastic electrode portion 4 is gradually increased as the pressing force is changed when the pressing force is, for example, about 1 to 10 N as described above. Accordingly, as illustrated in FIG. 10, the resistance is gently reduced. Thus, with the pressure-sensitive element a, a change in the pressing force can be accurately detected in a wide range of stress in accordance with a change in the resistance.

The contact resistance between the elastic electrode portion 4 and the conductive structures 3 is, for example, 10⁻⁵ Ω/cm² to 10⁻³ Ω/cm², and the surface resistivities of the elastic electrode portion 4 and the conductive layer 8 of the conductive structures 3 are, for example, equal to or less than 10 kΩ/sq.

The pressure-sensitive element 1 of the first embodiment is substantially configure so that the pressing force can e detected in accordance with the contact resistance between the elastic electrode portion 4 and the conductive structures 3.

In the case where the contact resistance between the elastic electrode portion 4 and the conductive structures 3 is relative excessively low, the resistance between the elastic electrode portion and the conductive layer 8 of the conductive structures 3 is low even when the contact area between the elastic electrode portion 4 and conductive structures 3 is reduced by reducing the pressing force acting on the electrode supporting component 5. Thus, unlikely that a change in the resistance corresponding to a change the pressing force is accurately detected.

In the case where the contact resistance between the elastic electrode portion 4 and the conductive structures 3 is relatively excessively high, the resistance between the elastic electrode portion 4 and the conductive layer 8 of the conductive structures 3 is high even when the contact area between the elastic electrode portion 4 and the conductive structures 3 is increased by increasing the pressing force acting on the electrode supporting component 5. Thus, it is unlikely that a change in the resistance corresponding to a change in the pressing force is accurately detected.

In the case where the surface resistivities of the elastic electrode portion 4 and the conductive layer 8 of the conductive structures 3 are higher than 10 kΩ/sq., the resistances of the elastic electrode portion 4 and the conductive layer 8 are higher than the contact resistance between the elastic electrode portion 4 and the conductive structures 3. As a result, the resistance between the elastic electrode portion 4 and the conductive layer 8 is not changed when the pressing force acts on the electrode supporting component 5.

Although the details will be described later, when the elastic electrode portion 4 and the conductive layer 8 of the conductive structures 3 are formed of ink that contains resin mixed with conductive particles, the resistances of the elastic electrode portion 4 and the conductive layer 8 can be set to desired values by adjusting, for example, the concentration of the conductive particles in the ink and the shapes of the elastic electrode portion 4 and the conductive layer 8. In this case, the materials are selected so that the elastic characteristics of the elastic electrode portion 4 and the conductive structures 3 are also obtained. Furthermore, when the conductive layer 8 of the conductive structures 3 and the elastic electrode portion 4 are formed by plating, the desired resistances can be obtained by desirably changing, for example, the densities of the plated films by adjusting the compositions, concentrations, temperatures, and so forth of plating solutions.

As illustrated in FIG. 7, when the electrode supporting component 5 is pressed toward the substrate 2, the pressed part of the electrode supporting component 5 and corresponding parts of the elastic electrode portion 4 bent so as to have protruding shapes that protrude in the pressing direction. This occurs since the electrode supporting component 5 and the elastic electrode portion 4 have flexibility.

When the electrode supporting component 5 is bent, the elastic electrode portion 4 is brought into contact with the tips of the conductive structures 3. Thus, the elastic electrode portion 4 and the conductive layer 8 of the conductive structures are electrically connected to one another.

When the electrode supporting component 5 continue to be bent to the substrate 2 side (the pressing force P continues to be increased), the elastic electrode portion 4 in contact with the conductive structures 3 continues to be deformed in a uniform manner, and the contact area between the elastic electrode portion 4 and the conductive structures continues to be changed in a uniform manner. Thus, the resistance between the elastic electrode portion 4 and the conductive layer 8 of the conductive structures 3 is continuously reduced.

The deformation of the elastic electrode portion 4 in the uniform manner referred to herein means as follows: that is, assuming that there are a plurality of the pressure-sensitive elements 1, the elastic electrode portions 4 having been brought into contact with the conductive structures 3 are deformed into a uniform shape when the electrode supporting components 5 of the plurality of pressure-sensitive elements 1 are pressed under the same pressing conditions. This deformation of the elastic electrode portions 4 in the uniform manner is realized when, as described above, the conductive structures 3 have a regular structure, are not deformed even when brought into contact with the elastic electrode portion 4, and are brought into contact with flat surface portions of the elastic electrode portion 4.

FIG. 11 illustrates a change in the electrical resistance between the elastic electrode portion 4 and the conductive layer 8 of the conductive structures 3 corresponding to a change in the pressing force acting on the electrode supporting component 5. As illustrated in FIG. 11, as the pressing force acting on the electrode supporting component 5 is continuously increased, the resistance between the elastic electrode portion 4 and the conductive layer 8 of the conductive structures 3 is continuously reduced. This continuous reduction of the resistance is realized by the increase in the uniform manner in the contact area between the elastic electrode portion 4 and the conductive structures 3 having a regular structure occurring as the pressing force is increased. Thus, the pressing force acting on the electrode supporting component 5 can be accurately detected in accordance with a change in the resistance.

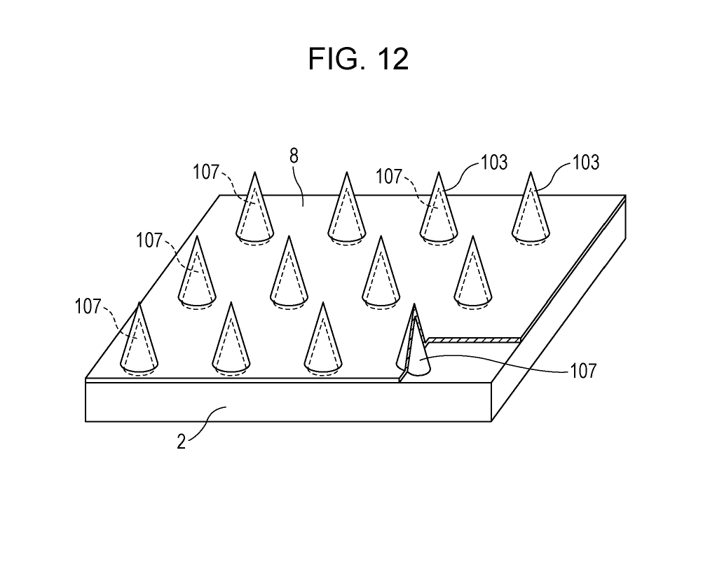

Although the conductive structures 3 of the first embodiment have a columnar shape, the shape of the conductive structures is not limited to this. The conductive structures may be, for example, conical conductive structures 103 as illustrated in FIG. 12. That is, the conductive structures 103 may be formed by providing conical structural components 107 on the substrate 2 and forming the conductive layer 8 on the surfaces of the conical structural components 107. Alternatively, the conductive structures have a frusto-conical shape or semi-spherical shape.

In particular, when the conductive structures 3 have a shape having a tapered surface such as a conical, frusto-conical, or semi-spherical shape, the contact area between the elastic electrode portion 4 and the conductive structures 3 is continuously increased as the pressing force acting on the electrode supporting component 5 is increased. That is, when focusing on one of the conductive structures 3, as the pressing force acting on the electrode supporting component 5 is increased, the elastic electrode portion 4 approaches the substrate 2. As the elastic electrode portion 4 approaches the substrate 2, the contact area between the elastic electrode portion 4 and the tapered surface of the one conductive structure 3 is continuously increased.

Furthermore, the surfaces of the conductive structures 3, in particular, the surfaces of the conductive structures 3 that can be brought into contact with the elastic electrode portion 4 have, for example, fine protrusions and recesses arranged in a regular manner. By adjusting, for example, the difference in the height of the fine protrusions and recesses arranged in the regular manner, the contact area between the conductive structures 3 and the elastic electrode portion 4 can be changed in a further continuous manner corresponding to a change in the pressing force acting on the electrode supporting component 5. As a result, a change in the pressing force acting on the electrode supporting component 5 can be accurately detected.

According to the first embodiment having been described, variation of change in the resistances corresponding to a change in the pressing force in the plurality of pressure-sensitive elements 1 is reduced, and the durability of the pressure-sensitive elements 1 can be improved.

That is, in the plurality of pressure-sensitive elements 1, since the elastic electrode portions 4 are deformed in the uniform manner as described above, the contact areas between the elastic electrode portions 4 and the conductive structures 3 are increased in the uniform manner as the pressing forces are increased. As a result, in each of the pressure-sensitive elements 1, variation of change in the resistance corresponding to a change in the pressing force can be reduced under the same pressing conditions. Furthermore, since the conductive structures can be designed in advance, variation among individual units of the plurality of pressure-sensitive elements can also be reduced.

Furthermore, since the conductive structures 3 having a protruding shape are brought into contact with the flat surfaces of the elastic electrode portion 4, cracks are unlikely to be caused (compared to the case where a hard electrode is brought into contact with the conductive structures 3 having the protruding shape). Thus, the pressure-sensitive element 1 has a high durability.

### Second Embodiment

Although a pressure-sensitive element according to a second embodiment is substantially the same as the pressure-sensitive element according to the above-described first embodiment, the conductive structures are different from those of the first embodiment. Thus, the details of the conductive structures of the pressure-sensitive element according to the second embodiment are described.

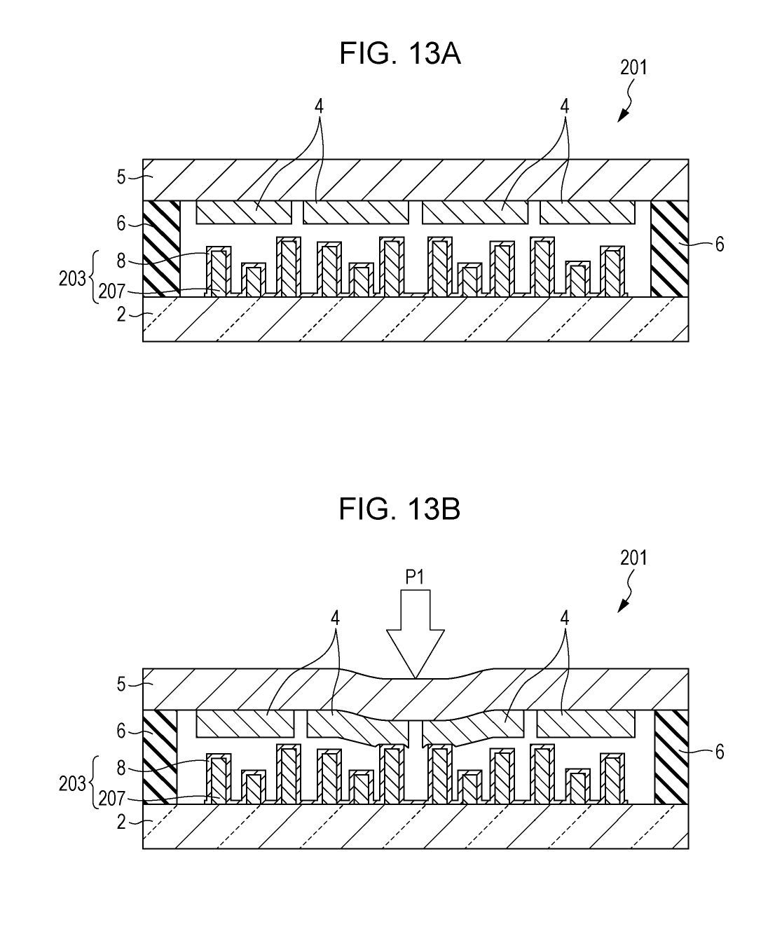

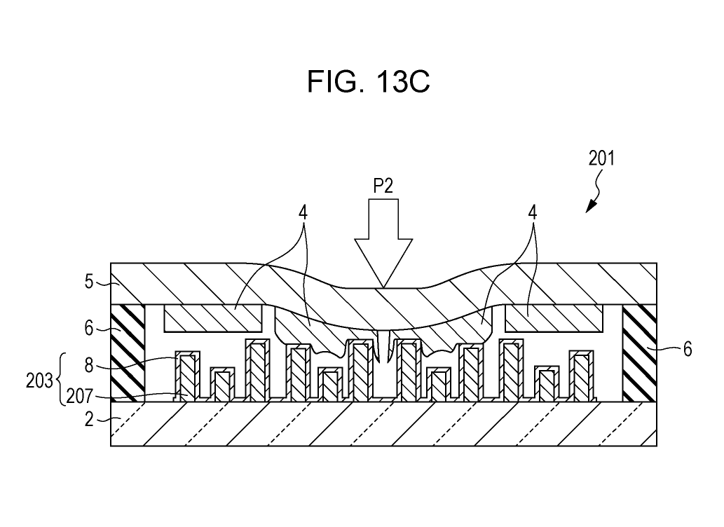

FIGS. 13A to 13C are schematic sectional views of a pressure-sensitive element 201 according to the second embodiment. FIG. 13A illustrates the pressure-sensitive element 201 to which the pressing force is not applied. FIG. 13B illustrates the pressure-sensitive element 201 to which a relatively small pressing force P1 is applied. FIG. 13C illustrates the pressure-sensitive element 201 to which a relatively large pressing force P2 is applied.

As illustrated in FIGS. 13A to 13C, the length of at least two of a plurality of conductive structures 203 of the pressure-sensitive element 201 from the substrate 2 to the tips of the conductive structures 203 is different from that of the other conductive structures 203. That is, the length of at least two of a plurality of structural components 207 is different from the other structural components 207.

In the case where the plurality of conductive structures 203 have a uniform length from the substrate 2 to the tips of the conductive structures 203, the elastic electrode portion 4 may be simultaneously brought into contact with the plurality of conductive structures 203 when the electrode supporting component 5 is pressed. This significantly increases the contact area between the elastic electrode portion 4 and the conductive structures 203, thereby significantly reducing the resistance between the elastic electrode portion 4 and the conductive layer 8.

In the case where at least two of the plurality of conductive structures 203 have the length, which is different from that of the other conductive structures 203, the relatively long conductive structures 203 are initially brought into contact with the elastic electrode portion 4 as illustrated in FIG. 13B when the electrode supporting component 5 is pressed by the relatively small pressing force P1.

Next, when the pressing force is increased from the pressing force P1 to the pressing force P2, the relatively short conductive structures 203 are brought into contact with the elastic electrode portion 4 as illustrated in FIG. 13C.

As described above, when the plurality of conductive structures 203 have different lengths, the number of the conductive structures 203 in contact with the elastic electrode portion 4 is increased as the pressing force acting on the electrode supporting component 5 is increased. Thus, by appropriately setting the lengths of the conductive structures 203, the contact area between the elastic electrode portion 4 and the conductive structures 203 can be gently changed as the pressing force is changed. That is, the resistance between the elastic electrode portion 4 and the conductive layer 8 can be gently changed as the pressing force is changed.

According to the second embodiment, the accuracy at which the pressing force acting on the electrode supporting component 5 is detected can be increased.

### Third Embodiment

A pressure-sensitive element according to a third embodiment is substantially the same as the pressure-sensitive element according to the second embodiment. However, the conductive structures of the third embodiment are different from those of the second embodiment. Thus, the details of the conductive structures of the pressure-sensitive element according to the third embodiment are described.

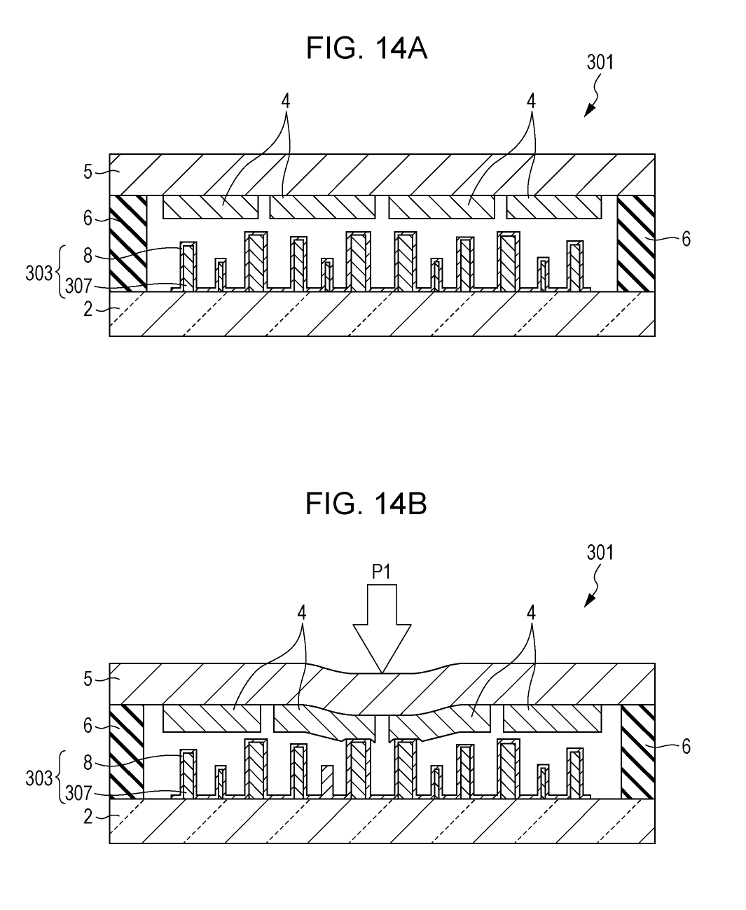

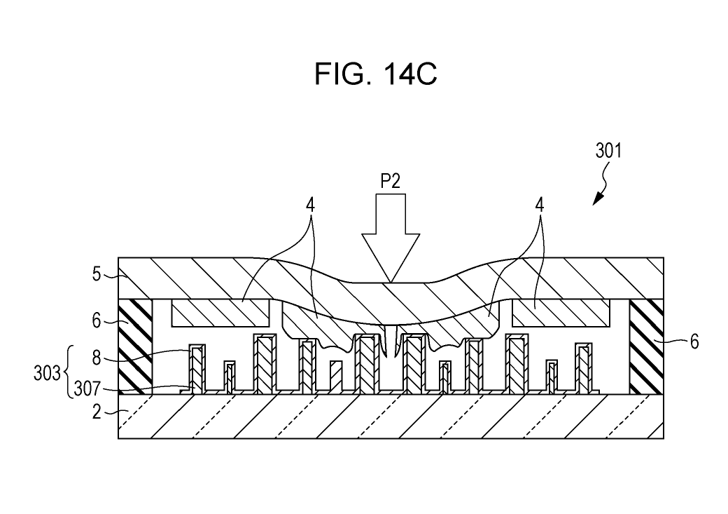

FIGS. 14A to 14C are schematic sectional views of a pressure-sensitive element 301 according to the third embodiment. FIG. 14A illustrates the pressure-sensitive element 301 to which the pressing force is not applied. FIG. 14B illustrates the pressure-sensitive element 301 to which the relatively small pressing force P1 is applied. FIG. 14C illustrates the pressure-sensitive element 301 to which the relatively large pressing force P2 is applied.

As illustrated in FIGS. 14A to 14C, as is the case with the above-described second embodiment, the length of at least two of a plurality of conductive structures 303 of the pressure-sensitive element 301 from the substrate 2 to the tips of the conductive structures 303 is different from that of the other conductive structures 303. In a projection in a direction in which the substrate 2 and the electrode supporting component 5 oppose each other, a projected sectional area of the relatively long conductive structures 303 is larger than that of the relatively short conductive structures 303. That is, a projected sectional area of relatively long structural components 307 is larger than a projected sectional area of relatively short structural components 307.

In the structure as described above, the relatively short conductive structures 303 are brought into contact with the elastic electrode portion 4 as illustrated in FIG. 14C after the relatively long conductive structures 303 have been brought into contact with the elastic electrode portion 4 as illustrated in FIG. 14B. At this time, the projected sectional area of the conductive structures 303, which are brought into contact with the elastic electrode portion 4 later, is smaller than that of the conductive structures 303, which are initially brought into contact with the elastic electrode portion 4. Thus, the contact area between the elastic electrode portion 4 and the conductive structures 303 is gently increased (compared to the case where the projected sectional area of the conductive structures 303 initially brought into contact with the elastic electrode portion 4 is the same as that of the conductive structures 303 brought into contact with the elastic electrode portion 4 later). Thus, by appropriately setting the size of the projected sectional area of the conductive structures 303, the contact area between the elastic electrode portion 4 and the conductive structures 303 can be gently changed as the pressing force is changed. That is, the resistance between the elastic electrode portion 4 and the conductive layer 8 can be gently changed as the pressing force is changed.

When the structural components 7 are formed by photolithoetching, the projected sectional area of the conductive structures can be designed in advance and the height can be changed by changing etching conditions.

According to the third embodiment, the accuracy at which the pressing force acting on the electrode supporting component 5 is detected can be further increased.

### Fourth Embodiment

The pressure-sensitive element according to the first to third embodiments described above has a plurality of conductive structures (structural components). In contrast, a pressure-sensitive element according to a fourth embodiment has a single conductive structure (structural component). Other structural elements of the fourth embodiment are the same as those of the above-described embodiments. Thus, the conductive structure according to the fourth embodiment is described.

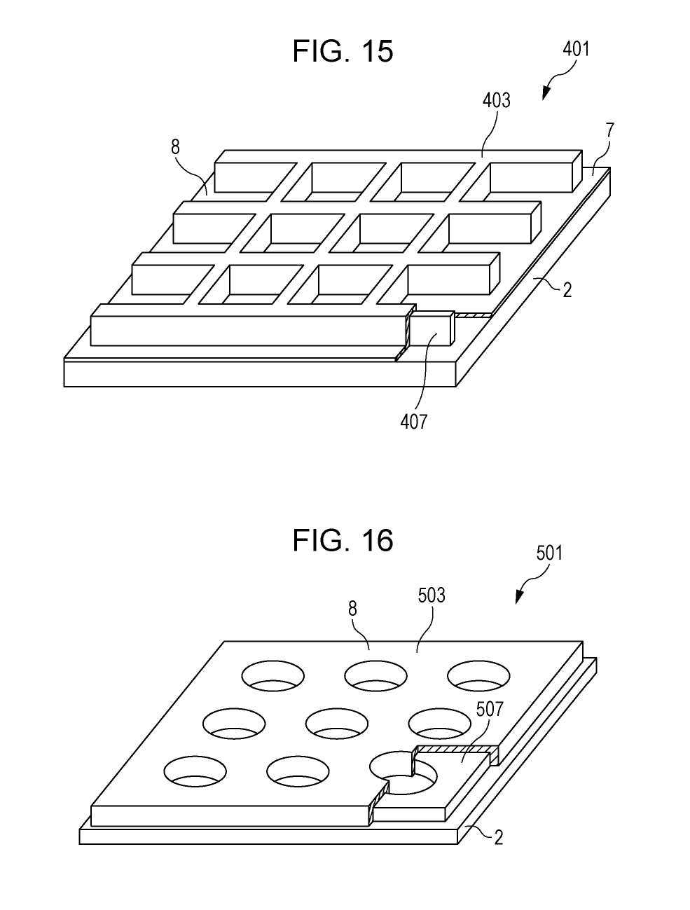

FIG. 15 illustrates a conductive structure 403 of a pressure-sensitive element 401 according to the fourth embodiment. A structural component 407 of the conductive structure 403 is a single component that extends from the substrate 2 toward the elastic electrode portion 4 and has a size extending over substantially the entirety of the substrate 2. The structural component 407 has a grid shape when seen in an opposing direction, in which the substrate 2 and electrode supporting component 5 oppose each other. That is, the structural component 407 has a plurality of through holes that penetrate therethrough in the opposing direction, in which the substrate 2 and the electrode supporting component 5 oppose each other, and the section perpendicular to the opposing direction is uniformly shaped. The conductive layer 8 having a uniform thickness is formed on the surface of the structural component 407 having the above-described shape. Thus, the conductive structure 403 also has a grid shape.

Instead of the grid-shaped conductive structure 403 (structural component 407), the conductive structure may be a conductive structure 503 (structural component 507) having a block shape, through which a plurality of through holes penetrate, as illustrated in FIG. 16.

With the conductive structure 403, 503 according to the fourth embodiment, the elastic electrode portion 4 can be brought into contact with inner circumferential surfaces of the plurality of through holes in addition to the surface of the conductive structure 403, 503 opposing the elastic electrode portion 4. Thus, as the pressing force acting on the electrode supporting component 5 is increased, a contact area between the elastic electrode portion 4 and the conductive structure 403, 503 is increased.

When the conductive structure is a single unit, the sectional area of which is uniform as is the case with the conductive structure 403, 503, the durability of the pressure-sensitive element is improved compared to the pressure-sensitive element that has a plurality of conductive structures having a shape such as the columnar shape as in the first embodiment.

According to the fourth embodiment, the pressing force acting on the electrode supporting component 5 can be accurately detected. Furthermore, the pressure-sensitive element 401, 501 having a high durability can be obtained.

### Fifth Embodiment

A pressure-sensitive element according to the embodiments of the present disclosure (including the above-described embodiments) may allow light in the visible range to be transmitted therethrough from the substrate 2 side to the electrode supporting component 5 side or a direction opposite to this direction.

That is, the structural elements of the the pressure-sensitive element 1 (201, 301, 401, 501), the elements including the substrate 2, the structural component 7 (107, 207, 307, 407, 507), the conductive layer 8, the elastic electrode portion 4, and the electrode supporting component 5, are transparent in the visible light range.

The transparent substrate 2 is formed of a material such as, for example, polyethylene terephthalate or polycarbonate.

The resin layer 10, 12 of the transparent structural component 7 (107, 207, 307, 407, 507) and the elastic electrode portion 4 are each formed of a material having a high transparency such as, for example, a silicone based resin, a styrene based resin, an acrylic resin such as polymethacrylic acid methyl, or a rotaxane based resin. The transparent conductive filler elements 11, which are formed of a material such as, for example, In₂O₃, ZnO, SnO₂, Au, Ag, Cu, or C, are contained in the transparent resin layer 10. In order to obtain a high transmittance, the shape and the size of the conductive filler elements 11 are a spherical shape of several ten nm or a wire shape having a diameter of several ten nm.

Alternatively, the surface of the transparent resin layer 12 may be coated with ink containing the above-described transparent conductive filler elements 11 as the transparent conductive layer 13.

The transparent conductive layer 8 of the conductive structures 3 is formed by performing sputtering on a transparent semiconductor material such as In₂O₃, ZnO, or SnO₂, or applying nano particles. Alternatively, wire-shaped particles of, for example, Au, Ag, Cu, or C having a diameter of several ten nm may be applied to the structural components 7 to form the conductive layer 8. Alternatively, the conductive layer 8 may be formed of a mesh pattern of about several to several ten μm formed by lines having a width of about several hundred nm to several hundred μm made of, for example, Ag or Cu.

According to the fifth embodiment, the pressure-sensitive element, which is transparent in the visible light range, can be obtained. The transparent pressure-sensitive element can be mounted on an image display surface such as, for example, a touch panel display.

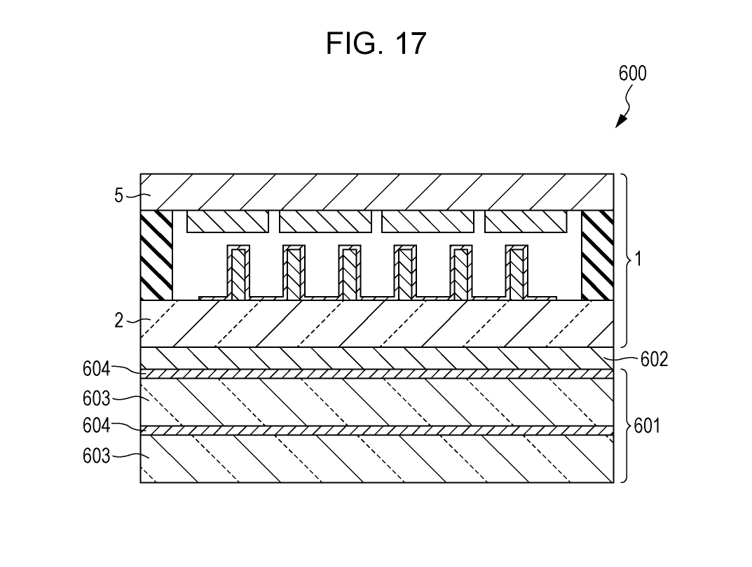

For example, FIG. 17 is a schematic sectional view of a touch panel 600 that includes the pressure-sensitive element according to the embodiments of the present disclosure (pressure-sensitive element 1 according to first embodiment as an example). As illustrated in FIG. 17, the touch panel 600 includes a sensor 601 and a cover film 602. The sensor 601 is stacked on the pressure-sensitive element 1 on the substrate 2 side and detects a pressed position of the electrode supporting component 5 of the pressure-sensitive element 1 when the electrode supporting component 5 is pressed. The cover film 602 is disposed between the pressure-sensitive element 1 and the sensor 601. In the touch panel 600 as described above, when a position on the surface of the electrode supporting component 5 is touched by, for example, a human finger, the touched position and the magnitude of a touching force (pressing force) can be detected. The sensor 601 may be stacked on the pressure-sensitive element 1 on the electrode supporting component 5 side. In this case, the pressure-sensitive element 1 is pressed through the sensor 601.

The sensor 601 may use a sensor that detects a pressed position on a flat surface by an electrostatic capacitive method.

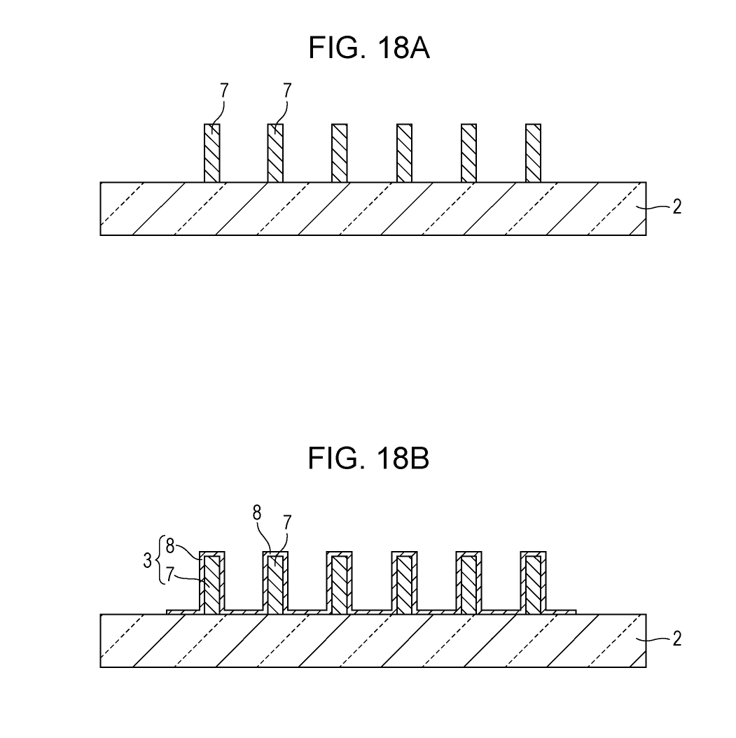

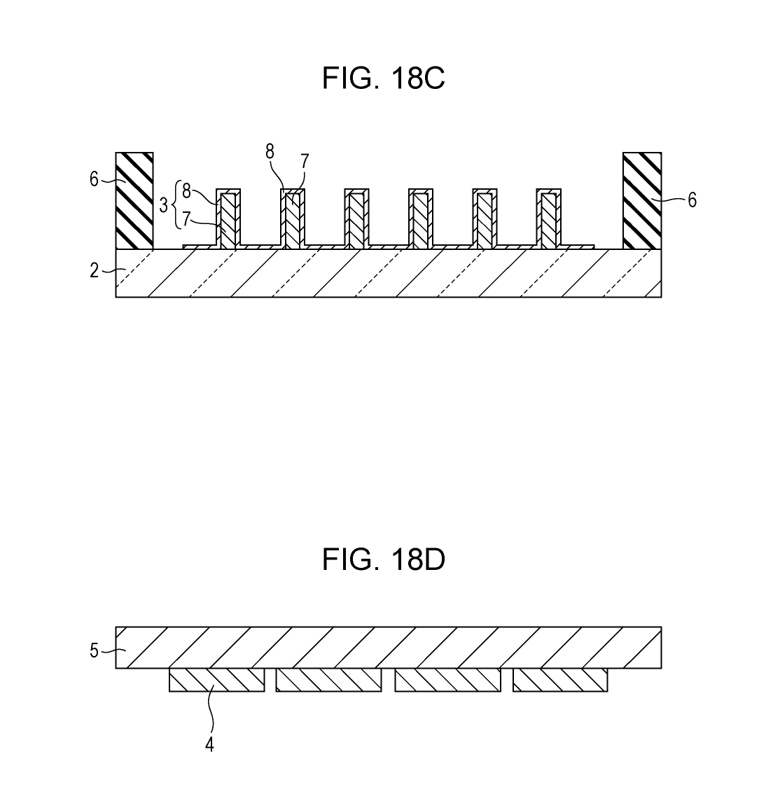

Hereafter, a method of producing the pressure-sensitive element according to the embodiments of the present disclosure is described. The method of producing the pressure-sensitive element 1 according to the first embodiment is described here with reference to FIGS. 18A to 18D.

Initially, as illustrated in FIG. 18A, the structural components 7 are formed on the substrate 2. The substrate 2, which has flexibility, is formed of a plastic such as, for example, polyethylene terephthalate, polycarbonate, or polyimide.

As the material of the structural components 7, a liquid polymer resin material is applied to the substrate 2. Examples of the liquid polymer resin material include materials such as, for example, a urethane resin, a silicone based resin, and a styrene based resin. In order to control the elastic modulus, the tincture, and the refractive index of the structural components 7, insulating filler may be mixed.

Next, the liquid polymer resin material applied to the substrate 2 is formed by using a mold having a pattern of protrusions and recesses, and the formed polymer resin material in the mold is cured. Thus, as illustrated in FIG. 18A, the columnar structural components 7 corresponding to the protrusion and recess pattern of the mold are formed.

This method of forming the structural components 7 uses a nano imprint technique. The nano imprint technique refers to a technique, in which a mold having a protrusion and recess pattern is pressed against resin as a target material of transfer so as to transfer the protrusion and recess pattern formed in the mold in the order of nm to the resin. Compared to the existing lithographic technique, fine patterns can be formed, and spatial structures having a slope such as a cone can be highly accurately formed by the nano imprint technique. With the nano imprint technique, a desired shape, length, and a sectional shape of the structural components 7 can be highly accurately and easily obtained by using a mold having a desired protrusion and recess pattern. Thus, the contact area between the elastic electrode portion 4 and the conductive structures 3 can be gently changed. Accordingly, the resistance between the elastic electrode portion 4 and the conductive layer 8 can be gently changed. As a result, the pressing force acting on the electrode supporting component 5 can be accurately detected.

Of course, the structural components 7 can be formed by a technique other than the nano imprint technique. Examples of such a technique include, for example, photolithoetching and a development and removal, technique. In the case of the photolithoetching, by adjusting the concentration and the flow rate of the etching liquid, the structural components 7 having a desired shape, length, sectional shape, and so forth can be formed.

Alternatively, the structural components 7 formed on the substrate 2 can be made as follows: that is, the liquid polymer resin material is mixed with the conductive filler elements, and the mixed liquid is poured into a mold and cured. After that, the formed part is released from the mold to produce the structural components 7. The structural components 7 are bonded to the substrate 2.

After the plurality of structural components 7 have been formed on the substrate 2 as illustrated FIG. 18A, ink containing conductive particles dispersed therein is continuously applied to the surfaces of the plurality of structural components 7 and the surface of the substrate 2 as illustrated in FIG. 18B. Thus, the conductive layer 8 coated on the plurality of structural components 7 and the substrate 2 is formed. Specifically, the conductive particles contained in the ink are selected from the group consisting of Au, Ag, Cu, C, ZnO, In₂O₃, and so forth. The conductive particles are dispersed in the ink. When the ink, in which the conductive particles are dispersed, is used, a paste made by mixing a binder resin, an organic solvent, and the conductive particles can be printed. Thus, the binder resin functions as a binder that causes the conductive particles to be bound to one another. This can improve the durability of the conductive layer 8

Furthermore, by appropriately adjusting the viscosity of the ink to be applied, the conductive layer 8 having a uniform thickness can be formed on the substrate 2 without being affected by the shapes, the sizes, the materials, and so forth of the substrate 2 and the structural components 7. Examples of the binder resin include, for example, ethylcellulose based resin, acrylic resin, and so forth. Examples of the organic solvent include, for example, terpineol, butyl carbitol acetate, and so forth.

The conductive layer 8 can be formed on the surfaces of the plurality of structural components 207 and the surface of the substrate 2 also by non-electrolytic plating. Non-electrolytic plating is a technique, by which a metal thin film, that is, the conductive layer 8, is formed by electrons supplied through oxidation reaction of a reducing agent added to the plating solution. Unlike electroplating, no current flows through the plating solution during non-electrolytic plating. Thus, not only conductive materials but also non-conductive materials such as plastic that form the substrate 2 can be plated. When plating non-conductive materials such as plastic, a catalyst that facilitates the oxidation reaction of the reducing agent is added to the plating solution. Although the catalyst is not particularly limited, for example, a Pd or the like is used.

By dipping the substrate 2 with the structural components 7 formed thereon into the plating solution containing a desired metal element, a layer of the desired metal element, that is, the conductive layer 8 is formed. The conductive layer 8 having a desired resistance can be formed by adjusting the composition ratio, the concentration, the temperature, and so forth of the plating solution.

The method of forming the conductive layer 8 is not limited to the above-described method, in which the ink containing the conductive particles dispersed in the ink is used, or the above-described method using the non-electrolytic plating. Other than these methods, the conductive layer 8 can be formed by, for example, a sol-gel method. The sol-gel method refers to a solution phase synthesis, in which a polymer solid is obtained by utilizing hydrolysis and polycondensation reaction of a metal alkoxide compound or a metal salt. Alternatively, the conductive layer 8 can be formed by, for example, a method such as sputtering or vapor deposition.

Thus, the conductive structures 3, in which the plurality of structural components 7 and the conductive layer 8 are integrated with one another, are formed.

After the conductive structures 3 have been formed on the substrate 2 as illustrated in FIG. 18B, the spacers 6, which are formed of an insulating resin such as a polyester resin or an epoxy resin, are made at the periphery of the substrate 2 as illustrated in FIG. 18C.

As illustrated in FIG. 18D, the elastic electrode portion 4 is formed at the electrode supporting component 5 formed of, for example, a flexible plastic. When the elastic electrode portion 4 is divided into a plurality of pieces as illustrated in FIGS. 1, 4, 5, and 6, the elastic electrode portion 4 is formed as the divided pieces. Examples of the plastic that forms the electrode supporting component 5 include, for example, polyethylene terephthalate, polycarbonate, polyimide, and so forth. In order to control the elastic modulus, the tincture, and the refractive index of the elastic electrode portion 4, insulating filler may be mixed.

In the case where the elastic electrode portion 4 illustrated in FIG. 8 is formed, a composite material, which is made by mixing the conductive filler elements 11 with a liquid polymer resin material such as a silicone based resin, a styrene based resin, an acrylic resin, or a rotaxane based resin, is printed in a pattern on the electrode supporting component 5. After that, when the composite material printed in a pattern is cured, the elastic electrode portion 4 illustrated in FIG. 8 is formed. The conductive filler elements 11 are formed of a material selected from the group consisting of Au, Ag, Cu, C, ZnO, In₂O₃, SnO₂, and so forth.

When the elastic electrode portion 4 illustrated in FIG. 9 is formed instead of the elastic electrode portion 4 illustrated in FIG. 8, the resin layer 12 is formed by printing the above-described polymer resin material in a pattern and curing the printed polymer resin material. The ink containing the conductive particles dispersed therein is printed in a pattern on the surface of the resin layer 12. Thus, the conductive layer 13 is formed. The conductive layer 13 can be formed by a sol-gel method or non-electrolytic plating. Alternatively, a resin material may be applied entirely to the electrode supporting component 5, and after that, the resin layer 12 of the elastic electrode portion 4 may be formed by a technique such as photolithoetching or a development and removal technique.

Then, by providing the substrate 2 illustrated in FIG. 18C, at which the conductive structures 3 and the spacers 6 have been formed, with the electrode supporting component 5 illustrated in FIG. 18D, at which the elastic electrode portion 4 has been formed, such that the elastic electrode portion 4 opposes the conductive structures 3, the pressure-sensitive element 1 illustrated in FIG. 2 is made.

Next, a method of producing the touch panel 600 that includes the pressure-sensitive element 1 according to the first embodiment of the present disclosure is described with reference to FIG. 17.

Initially, transparent conductive films 604 are formed on transparent substrates 603. Next, two transparent substrates 603, on each of which the transparent conductive film 604 has been formed, are superposed with each other. Thus, the sensor 601 that detects a touched position in the touch panel 600 is made.

Next, the cover film 602 is provided on the sensor 601. Then, the pressure-sensitive element 1 is provided on the cover film 602 such that the substrate 2 is in contact with the cover film 602. As a result, the touch panel 600 including the pressure-sensitive element 1 is made.

The sensor 601 may be stacked on the pressure-sensitive element 1 on the electrode supporting component 5 side. The sensor 601 may use a sensor that detects a pressed position on a flat surface by an electrostatic capacitive method.

The pressure-sensitive element, the method of producing the pressure-sensitive element, the touch panel including the pressure-sensitive element, and the method of producing the touch panel according to the embodiments of the present disclosure have been described. However, the present disclosure is not limited to these, and it should be understood that various changes can be made by those skilled in the art without departing from the scope of the disclosure defined in the claims.

The present disclosure includes the following forms of implementation.

A pressure-sensitive element according to a form of implementation of the present disclosure includes a substrate, a conductive structure, an elastic electrode portion, and an electrode supporting component. The conductive structure extends from the substrate. The elastic electrode portion opposes a tip of the conductive structure. The electrode supporting component opposes the substrate with the conductive structure and the elastic electrode portion interposed therebetween, supports the elastic electrode portion, and has flexibility. In the pressure-sensitive element, the conductive structure includes a structural component which extends from the substrate and which has a higher elastic modulus than that of the elastic electrode portion, and a conductive layer which is coated on a surface of the structural component. In the pressure-sensitive element, the elastic electrode portion has a flat surface which opposes the conductive structure and which capable of being brought into contact with the conductive structure.

According to the form of implementation of the present disclosure, variation of change in the resistance corresponding to change in the pressing force can be reduced, and the durability of the pressure-sensitive element can be improved.

For example, the pressure-sensitive element according to the above-described form of implementation, the elastic electrode portion may include a resin layer and conductive filler contained in the resin layer.

For example, in the pressure-sensitive element according to the above-described form of implementation, the elastic electrode portion may include a resin layer and a conductive layer coated on a surface of the resin layer.

For example, in the pressure-sensitive element according to the above-described form of implementation, the conductive structure may have a columnar, conical, frusto-conical or semi-spherical shape.

For example, in the pressure-sensitive element according to the above-described form of implementation, a plurality of the conductive structures may be provided, and the conductive layers of the plurality of conductive structures may be in contact with one another.

For example, in the pressure-sensitive element according to the above-described form of implementation, lengths of at least two of the plurality of conductive structures from the substrate to the tips of the conductive structures may be different from each other.

For example, in the pressure-sensitive element according to the above-described form of implementation, when when at least two of the plurality of conductive structures, lengths of which from the substrate to the tips of the conductive structures are different from each other, are projected in an opposing direction in which the substrate and the electrode supporting component oppose each other, a projected sectional area of a relatively long conductive structure or relatively long conductive structures of the at least two conductive structures may be larger than a projected sectional area of a relatively short conductive structure or relatively short conductive structures of the at least two conductive structures.

For example, in the pressure-sensitive element according to the above-described form of implementation, the conductive structure may be a single component. In this case, the section of the conductive structure in a direction perpendicular to an opposing direction, in which the substrate and the electrode supporting component oppose each other, is uniformly shaped, and the conductive structure has a plurality of through holes penetrating therethrough in the opposing direction.

For example, in the pressure-sensitive element according to the above-described form of implementation, the conductive structure may have a grid shape when seen in the opposing direction.

For example, in the pressure-sensitive element according to the above-described form of implementation, the conductive layer may be continuously coated on the structural component that extends from the substrate and an exposed portion of the substrate.

For example, in the pressure-sensitive element according to the above-described form of implementation, the substrate may have flexibility.

For example, in the pressure-sensitive element according to the above-described form of implementation, light in a visible range may be able to be transmitted in a direction from the substrate side to the electrode supporting component side or in a direction opposite to the direction from the substrate side to the electrode supporting component side.

A touch panel according to another form of implementation of the present disclosure includes the above-described pressure-sensitive element and a sensor that is stacked on the pressure-sensitive element and that detects a pressed position in the pressure-sensitive element when the pressure-sensitive element is pressed.

A method of producing a pressure-sensitive element according to a yet another implementation of the present disclosure includes the following steps: providing a structural component on a substrate such that the structural component extends from the substrate; forming a conductive structure by providing a conductive, layer such that the conductive layer is coated on the structural component and the substrate; providing an elastic electrode portion on an electrode supporting component; and arranging the electrode supporting component opposite the substrate such that the elastic electrode portion and the conductive structure are interposed between the substrate and the electrode supporting component. In this method, the conductive structure has a higher elastic modulus than that of the elastic electrode portion, and the elastic electrode portion has a flat surface which opposes the conductive structure and which is capable of being brought into contact with the conductive structure.

For example, in the method of producing the pressure-sensitive element according to yet the other form of implementation described above, a plurality of the conductive structures may be provided with the conductive layers thereof being in contact with one another on the substrate, and lengths of at least two of the plurality of conductive structures from the substrate to tips of the conductive structures may be different from each other.

For example, in the method of producing the pressure-sensitive element according to yet the other form of implementation described above, when the at least two conductive structures, the lengths of which from the substrate to the tips of the conductive structures are different from each other, are projected in an opposing direction in which the substrate and the electrode supporting component oppose each other, a projected sectional area of a relatively long conductive structure or relatively long conductive structures of the at least two conductive structures may be larger than a projected sectional area of a relatively short conductive structure or relatively short conductive structures of the at least two conductive structures.

For example, in the method of producing the pressure-sensitive element according to yet the other form of implementation described above, the structural component may be formed by applying a polymer resin material to the substrate, forming the polymer resin material, which has been applied, by a mold having a protrusion and recess pattern, and curing the polymer resin material, which has been formed in the mold.

For example, in the method of producing the pressure-sensitive element according to yet the other form of implementation described above, the conductive layer may be formed by coating ink, which contains conductive particles dispersed in the ink, on the substrate and the structural component extending from the substrate.

For example, in the method of producing the pressure-sensitive element according to yet the other form of implementation described above, the conductive layer coated on the substrate and the structural component extending from the substrate may be formed by plating.

For example, in the method of producing the pressure-sensitive element according to yet the other form of implementation described above, the elastic electrode portion may be formed by printing a slurry, which contains an elastic resin and conductive filler dispersed in the elastic resin, in a pattern on the electrode supporting component, and curing the slurry having been printed in the pattern.

For example, in the method of producing the pressure-sensitive element according to yet the other form of implementation described above, the elastic electrode portion may be formed by printing an elastic resin in a pattern on the electrode supporting component, curing the elastic resin having been printed in the pattern on the electrode supporting component, and printing a conductive paste in a pattern on a surface of the elastic resin having been cured.

A method of producing a touch panel according to yet another form of implementation of the present disclosure includes the steps of preparing the pressure-sensitive element produced by the above-described method; making a sensor that detects a pressed position of the pressure-sensitive element when the pressure-sensitive element is pressed; and stacking the pressure-sensitive element on the sensor.

The pressure-sensitive element according to the present disclosure can be effectively utilized in touch panels of car navigation systems, smartphones, and so forth. As a result, convenience of the touch panels for the user can be improved.

What is claimed is:

1. A pressure-sensitive element comprising:
a substrate;
a conductive structure that extends from the substrate;
an elastic electrode portion that opposes a tip of the conductive structure; and
an electrode supporting component that opposes the substrate with the conductive structure and the elastic electrode portion interposed therebetween, that supports the elastic electrode portion, and that has flexibility,
wherein the conductive structure includes
a structural component which extends from the substrate and which has a higher elastic modulus than that of the elastic electrode portion, and
a conductive layer which is coated on a surface of the structural component, and
wherein the elastic electrode portion has a flat surface which opposes and contacts the conductive component.

2. The pressure-sensitive element according to claim 1,
wherein the elastic electrode portion includes a resin layer and conductive filler contained in the resin layer.

3. The pressure-sensitive element according to claim 1,
wherein the elastic electrode portion includes a resin layer and a conductive layer coated on a surface of the resin layer.

4. The pressure-sensitive element according to claim 1,
wherein the conductive structure has a columnar, conical, frusto-conical, or semi-spherical shape.

5. The pressure-sensitive element according to claim 1,
wherein a plurality of the conductive structures are provided, and the conductive layers of the plurality of conductive structures are in contact with one another.

6. The pressure-sensitive element according to claim 5,
wherein lengths of at least two of the plurality of conductive structures from the substrate to the tips of the conductive structures are different from each other.

7. The pressure-sensitive element according to claim 5,
wherein, when at least two of the plurality of conductive structures, lengths of which from the substrate to the tips of the conductive structures are different from each other, were projected in an opposing direction in which the substrate and the electrode supporting component oppose each other, a projected sectional area of a relatively long conductive structure or relatively long conductive structures of the at least two conductive structures is larger than a projected sectional area of a relatively short conductive structure or relatively short conductive structures of the at least two conductive structures.

8. The pressure-sensitive element according to claim 1,
wherein the conductive structure is a single component, the section of the conductive structure in a direction perpendicular to an opposing direction, in which the substrate and the electrode supporting component oppose each other, is uniformly shaped, and the conductive structure has a plurality of through holes penetrating therethrough in the opposing direction.

9. The pressure-sensitive element according to claim 8,
wherein the conductive structure has a grid shape when seen in the opposing direction.

10. The pressure-sensitive element according to claim 1,
wherein the conductive layer is continuously coated on the structural component that extends from the substrate and an exposed portion of the substrate.

11. The pressure-sensitive element according to claim 1,
wherein the substrate has flexibility.

12. The pressure-sensitive element according to claim 1,
wherein light in a visible range is able to be transmitted in a direction from the substrate side to the electrode supporting component side or in a direction opposite to the direction from the substrate side to the electrode supporting component side.

13. A touch panel comprising:
the pressure-sensitive element according to claim 1; and
a sensor that is stacked on the pressure-sensitive element and that detects a pressed position in the pressure-sensitive element when the pressure-sensitive element is pressed.

14. A method of producing a pressure-sensitive element, the method comprising the steps of:
providing a structural component on a substrate such that the structural component extends from the substrate;
forming a conductive structure by providing a conductive layer such that the conductive layer is coated on the structural component and the substrate;
providing an elastic electrode portion on an electrode supporting component; and
arranging the electrode supporting component opposite the substrate such that the elastic electrode portion and the conductive structure are interposed between the substrate and the electrode supporting component,
wherein the conductive structure has a higher elastic modulus than that of the elastic electrode portion, and
wherein the elastic electrode portion has a flat surface which opposes and contacts the conductive component.

15. The method according to claim 14,
wherein a plurality of the conductive structures are provided with the conductive layers thereof being in contact with one another on the substrate, and
wherein lengths of at least two of the plurality of conductive structures from the substrate to tips of the conductive structures are different from each other.

16. The method according to claim 15,
wherein, when the at least two conductive structures, the lengths of which from the substrate to the tips of the conductive structures are different from each other, are projected in an opposing direction in which the substrate and the electrode supporting component oppose each other, a projected sectional area of a relatively long conductive structure or relatively long conductive structures of the at least two conductive structures is larger than a projected sectional area of a relatively short conductive structure or relatively short conductive structures of the at least two conductive structures.

17. The method according to claim 14,
wherein the structural component is formed by applying a polymer resin material to the substrate, forming the polymer resin material, which has been applied, by a mold having a protrusion and recess pattern, and curing the polymer resin material, which has been formed in the mold.

18. The method according to claim 14,
wherein the conductive layer is formed by coating ink, which contains conductive particles dispersed in the ink, on the substrate and the structural component extending from the substrate.

19. The method according to claim 14,
wherein the conductive layer coated on the substrate and the structural component extending from the substrate are formed by plating.

20. The method according to claim 14,
wherein the elastic electrode portion is formed by printing a slurry, which contains an elastic resin and conductive filler dispersed in the elastic resin, in a pattern on the electrode supporting component, and curing the slurry having been printed in the pattern.

21. The method according to claim 14,
wherein the elastic electrode portion is formed by printing an elastic resin in a pattern on the electrode supporting component, curing the elastic resin having been printed in the pattern on the electrode supporting component, and printing a conductive paste in a pattern on a surface of the elastic resin having been cured.

22. A method of producing a touch panel, toe method comprising the steps of:
preparing the pressure-sensitive element produced by the method according to claim 14;
making a sensor that detects a pressed position of the pressure-sensitive element when pressure-sensitive element is pressed; and
stacking the pressure-sensitive element on the sensor.
